(19) United States
(12) Patent Application Publication
(10) Pub. No.: US 2023/0311679 A1
(43) Pub. Date: Oct. 5, 2023

(54) Charging Plug, Charger, and Method for Charging an Electric Vehicle

(71) Applicant: Juice Technology AG, Cham (CH)

(72) Inventor: Christoph ERNI, Bachenbülach (CH)

(73) Assignee: Juice Technology AG, Cham (CH)

(21) Appl. No.: 18/024,888

(22) PCT Filed: Aug. 16, 2021
(86) PCT No.: PCT/EP2021/072705

§ 371 Date: Mar. 6, 2023

(30) Foreign Application Priority Data
Sep. 4, 2020 (DE) 10 2020 123 216.0

(51) Int. Cl. B60L 53/16; B60L 53/30; B60L 53/66; B60L 53/18

(52) U.S. Cl. CPC B60L 53/16; B60L 53/305; B60L 53/665; B60L 53/18

(57) ABSTRACT

A charging plug for charging a battery of an electric vehicle includes a consumer-side connector for connecting the charging plug to a port of the electric vehicle and an actuation element for initiating at least one function from a plurality of eligible functions associated with the charging process and assigned by an operator.

### FIELD OF THE INVENTION

The present invention relates to systems and components thereof for charging a battery of an electric vehicle.

### BACKGROUND OF THE INVENTION

Electric vehicles are usually supplied with energy at mobile or stationary (installed) charging stations or chargers. The energy storage devices (batteries) of such vehicles are connected to the public power supply grid via a charging control device and charged accordingly. To this end, the electric vehicle has a port having a plurality of electrical contacts into which a matching charging plug is plugged. A mobile charger, in addition to the charging plug, usually comprises at least one charging cable, the charging control device and, on the grid side, a connecting element for connection to the power supply grid.

Particularly in unfavourable external conditions, for example in the event of cold conditions, snow, ice, moisture, darkness, dirt or mud, operating such a charger by inserting the charger into the port of the electric vehicle, identifying the user at the charger, and implementing appropriate settings on the charger can be laborious and can entail difficulties and additional effort. By way of example, the display and the operating elements of a charger, which may be provided on the charging control device, may first have to be cleared of snow, dirt, and moisture prior to the charging process. This involves effort by the user and reduces comfort, and may also reduce motivation for a user to operate an electric vehicle.

The prior art discloses charging plugs that have passive components such as, for example, electrical resistors in order to indicate to the controller in the electric vehicle the maximum amount of current or power the present infrastructure is able to provide for charging purposes. One example of such a disclosure is WO 2011/012 451 A1.

Other systems comprise a charging plug that has a button by way of which it is possible to open a charging flap that covers the port on the electric vehicle. A system known as the “Tesla Charge Port Opener” is such a system. DE 10 2016 220 513 A1 discloses a charging device in which various predefined functions that are defined ex-works are able to be initiated through differing actuation of such an actuation element on the charging plug. By way of example, differing frequency or duration of the actuation enables a selection of functions such as activate, deactivate, interrupt and continue the charging process. According to DE 10 2012 021 502 A1, a display may also be provided on the charging plug in order to further increase ease of use.

### OBJECTS OF THE INVENTION

It is an object of the present invention to provide a charging plug, a charger and a method for charging a battery of an electric vehicle, all of which allow a user to perform the process of charging his or her electric vehicle easily and comprehensively, even under adverse conditions.

A further object of the present invention is to provide a charging plug, a charger, and a method for charging an electric vehicle, which, through user-specific assignment of the functions to be initiated by actuation of an actuation element, will make the process of charging an electric vehicle simpler and more convenient.

Yet another object of the present invention is to provide electric vehicle charging which highly flexible with respect to the functions available to the user or operator.

### SUMMARY OF THE INVENTION

According to one aspect of the invention, a charging plug for charging a battery of an electric vehicle comprises a consumer-side connector for connecting the charging plug to a charging port of the electric vehicle and an actuation element for initiating at least one function that is associated with the charging process of the electric vehicle. The actuation element is configured to be assigned the at least one function by the operator, which function is selectable by the operator from a plurality of eligible functions.

This inventive charging plug for charging an electric vehicle allows the charging process to be performed in a particularly simple and convenient manner. The operator, usually the driver or the user of the electric vehicle, may assign to the actuation element on the charging plug at least one function that he or she selects at any desired time. Such function or functions may be initiated in subsequent charging processes through simple actuation of the actuation element rather than, for example, using a dedicated actuation element on associated component such as on a charging station, a charger, a charging control device or on the electric vehicle. It is then no longer necessary to pick up a charger lying on the ground and clear any dirt therefrom in order to initiate a selected function.

The operator or driver of the electric vehicle may assign the at least one function from the plurality of eligible functions by the operator The operator himself may thus decide which function or functions should be linked to the actuation element and assign it to the actuation element. The charging plug is accordingly configured such that the function of the actuation element, or the function that is able to be initiated by actuating the actuation element, is changed or assigned to the actuation element by the operator himself. In other words, the charging plug may be configured such that the function of the actuation element is programmable by the operator. The operator may thus, for example, select whether a first function or a second function different from the first function from the plurality of functions is initiated in the event of the same type of actuation of the actuation element, for example, by actuation duration or frequency. This allows a high degree of flexibility and user-friendliness in connection with the charging process of the electric vehicle. By contrast, in the prior art, the operator is tied to the functions of the actuation element that are defined ex-works and to the functions assigned to a specific type of actuation and is not able to influence them himself.

The at least one function may be assigned to the actuation element or may be assigned by programming a control or processing unit associated with the actuation element. The charging plug may itself comprise such a control or processing unit. The control or processing unit is preferably, however, included in a charging station, a charger, or in a charging control device.

The function associated with the charging process may generally be a function of the electric vehicle, of a charging control device, or of a charger, or may be another function linked to the charging process, such as, for example, the identification of the vehicle or operator.

The actuation element is configured to be on the charging plug, which is plugged into a charging port of the electric vehicle in order to charge the electric vehicle. The charging plug may comprise a housing on which the actuation element is arranged. The housing of the charging plug may have a gripping area for the operator to grip the charging plug, and the actuation element is preferably arranged in this gripping area or directly next to the gripping area in order to allow simple actuation. By way of example, the actuation element is arranged on the housing of the charging plug such that it is able to be actuated by the thumb or index finger while the charging plug is being held.

In embodiments, the charging plug may comprise a plurality of electrical lines for connecting the consumer-side connector of the charging plug to a charging control device. The charging plug includes a plurality of electrical contacts for connection to the electric vehicle, and the plurality of electrical lines is configured to connect the plurality of electrical contacts to corresponding connectors of the charging control device. In this case, one line of the plurality of electrical lines of the charging plug (for example, a control pilot) may serve as signal line for communicatively connecting the consumer-side connector of the charging plug, and thus the electric vehicle, to the charging control device.

According to an embodiment, the charging plug my additionally comprise a signal line for communicatively connecting the actuation element to the charging control device. This signal line may also be connected to the consumer-side connector of the charging plug and thus serve for communicatively connecting the actuation element to the electric vehicle. The signal lines may also be designed integrally as one signal line.

Using the signal line for communicatively connecting the actuation element to the charging control device, the actuation element is configured such that, when actuated, transmits an actuation signal to the charging control device, and, in particular to a control or processing unit of the charging control device. The control or processing unit may process the actuation signal in accordance with the assigned function and initiate the function.

In embodiments, the plurality of eligible functions may comprise one or more of the following functions:
a) opening a charging flap of the electric vehicle in order to expose the charging port,
b) closing the charging flap after the charging process has ended,
c) activating charging readiness of the electric vehicle in order to enable the charging process,
d) activating the charging process,
e) interrupting or deactivating the charging process,
f) continuing the charging process,
g) setting a charging power or a charging current before or during the charging process,
h) controlling the charging control device or the settings of the charging control device,
i) controlling or setting a superordinate charging management system,
j) outputting light signals, audio signals, light information, or audio information on the charging plug, on a charger, or on a mobile terminal,
k) functions regarding the environment of the electric vehicle to be charged, such as at a parking space of the electric vehicle, and
i) identifying and/or authorizing an operator.

The at least one function may relate not only to the actual electric charging process but may also relate to the billing thereof and further subsequent actions. The list of the plurality of eligible functions may be expanded as desired, depending on the respective charging infrastructure that is present and the properties or functionality of the electric vehicle.

A superordinate charging management system according to step i) may, for example, activate one or more charging devices, perform load management (for example, the strength and duration of charging) or perform prioritization or time management (priority, order, and/or time of the charging of multiple consumers). This is particularly advantageous when the charging management system manages a plurality of chargers or charging stations.

Light signals, audio signals, light information, or audio information may be output according to step j) in order to, for example, signal a state of charge of the electric vehicle or a need for an action. In order to output light signals or light information, the charging plug preferably comprises a corresponding display device that may be separate from the actuation element or may be implemented by illuminating the actuation element or its surroundings. In order to output audio signals or audio information, the charging plug preferably includes a corresponding audio signal device. It will be understood that the display device and/or the audio signal device may be formed selectively on the charger or a charging station, by a mobile terminal, or at another appropriate location.

A function relating to the surroundings of the electric vehicle to be charged according to step k) may comprise switching on a garage light or activating hydropower or solar power in order to charge the electric vehicle, and may take place, for example, using a home network and/or the Internet.

The identification and/or authorization of an operator according to step i) may be used in order to activate, to decline or to end the charging process depending on the identification of an operator. At the same time, an identification of the operator may be used to bill the charging process. All of the eligible functions are initiated by actuating the actuation element.

In one embodiment, the actuation element is configured to be assigned the at least one function by the operator using a user interface. The user interface is preferably implemented as an app on a mobile terminal, as a display and operating element on the charger, on the charging control device, or in wired form via a PC or a browser application. This may enable simple and fast programming of the actuation element.

In order to achieve simple and reliable handling of the actuation element, the actuation element is preferably configured as a button, as a switch, or as a sensor (for example, as a touch sensor or temperature sensor).

In embodiments, the consumer-side connector of the charging plug may be configured as an IEC Type 2, an IEC Type 1, a CHAdeMO, or as a CCS connector. Such charging plugs have become largely predominant on the market and therefore cover a multiplicity of charging options and possible electric vehicles have corresponding charging ports.

In one embodiment, the actuation element is configured to be assigned at least two functions of the plurality of eligible functions, wherein the at least two functions are able to be initiated by different types of actuation of the actuation element. For example, a first function of the plurality of functions may be initiated by a first type of actuation and a second function of the plurality of functions may be initiated by a second type of actuation.

The different types of actuation may comprise different actuation durations (for example, a long or short press), different numbers of actuations (for example, single or multiple presses), different actuation frequencies (for example, multiple quick or multiple slow presses) or a combination thereof. According to a further aspect of the invention, a charger for charging a battery of an electric vehicle comprises a charging control device for regulating parameters of the charging of the battery of the electric vehicle, a grid-side connector for connecting the charger to a power grid, and a charging plug according to the invention for connecting the charger to the electric vehicle. The grid-side connector and the charging plug are connected to the charging control device.

In embodiments, the charger may be configured as a mobile charger, in which the grid-side connector is connected to the charging control device by way of a first charging cable and the consumer-side connector of the charging plug is connected to the charging control device by way of a second charging cable. More advantageously, the mobile charger may be configured such that it is transportable in an electric vehicle. With such a mobile charger and associated adapters for connection to the public power supply grid, the user is equipped for all eventualities for being able to charge the electric vehicle in a wide variety of countries and environments. Charging is thus possible in a manner largely independent of the predefined infrastructure.

The charger may however also be configured as a stationary charger, such as, for example, as a wallbox or public charging station. In such cases, at least the consumer-side connector of the charging plug is connected to the charging control device by way of a charging cable. The charging control device may then be connected directly to the power grid on the grid side.

The grid-side connector may be configured or designed for example as a shock-proof, camping, CEE-16, CEE-32, IEC Type1 or IEC Type 2 connector. It is possible to connect the grid-side connector to the charging control device by way of a releasable connection in order to be able to connect different types of connectors to the charging control device. The grid-side connector may thereby easily be adapted to the removal option that is respectively present. This is especially advantageous in the case of a mobile charger.

The charging control device is configured to regulate a charging current for charging the battery of the electric vehicle and/or to monitor a charging process for charging the battery of the electric vehicle. To this end, the charging control device comprises a control unit that is able to receive and process signals from the electric vehicle, from the consumer-side connector, and from the grid-side connector.

In embodiments, the charging control device may furthermore comprise a processing unit that is configured to process the actuation signals received from the actuation element and to initiate the at least one function following this processing. To this end, the processing unit transmits corresponding signals to the charging plug or the electric vehicle or to the control unit of the charging control device. The processing unit may also be configured as part of the control unit. As an alternative, the charging plug may have a corresponding processing unit. The processing unit may however also be outsourced to a back-end system on a server. This makes sense, for example, when a multiplicity of charging stations is provided in a car park and is managed centrally by a control unit.

In one preferred embodiment, the charger furthermore comprises a user interface for the operator to assign the at least one function to the actuation element. The user interface, as described above, may be implemented as an app, on the charger, on the charging control device, or in wired form. For example, the charger may comprise a display and at least one operating element by way of which the actuation element is able to be assigned the at least one function. For a wired user interface, the charger may comprise a corresponding connector such as, for example, a network connector.

The charger, and in particular the charging control device, may comprise a communication interface, such as, for example, a wireless communication interface. The charging control device may be configured to communicate with mobile terminals, other chargers or charging stations, a server, a database, or a cloud by way of the communication interface. One particularly convenient application includes using a wireless communication interface that may communicate with mobile terminals, such as for example, smartphones, and the user interface is an app on a mobile terminal.

In one embodiment, the actuation element may be assigned or programmed using the processing unit. The operator enters a corresponding selection of the at least one function using the user interface, and the processing unit processes this selection, assigns the actuation element the corresponding at least one function, and stores this association. If the processing unit is provided in the charging plug, the communication interface and/or user interface may also be provided on the charging plug.

According to a further aspect of the invention, a method for charging the battery of an electric vehicle comprises the steps of:
a) providing a charger for charging the battery;
b) the operator assigning the at least one function to the actuation element;
c) connecting the grid-side connector of the charger to a power grid;
d) connecting the consumer-side connector of the charging plug to the electric vehicle;
e) actuating the actuation element in order to initiate the at least one function when required; and
f) charging the electric vehicle using the charger.

In this inventive method, the charger includes (i) a charging control device for regulating parameters for the charging of the battery, (ii) a grid-side connector for connecting the charger to a power grid, wherein the grid-side connector is connected to the charging control device, and (iii) a charging plug for connecting the charger to the electric vehicle, wherein the charging plug is connected to the charging control device. Further, the charging plug includes (1) a consumer-side connector for connecting the charging plug to a charging port of the electric vehicle and (2) an actuation element for an operator or user of the electric vehicle to initiate at least one function that is associated with the charging process. The actuation element is configured to be assigned the at least one function by the operator, the at least one function being selectable by the operator from a plurality of eligible functions. The actuation element is thereby able to be assigned a desired function before the charger is used to charge the electric vehicle, in order to simplify subsequent charging processes.

It will be understood that all features, functions, and operations described with reference to the charging plug according to the invention and the charger according to the invention may be transferred to the method according to the invention and formulated appropriately as method steps.

In embodiments, steps a) to c) may take place before the charger is put into service and then again when required, for example, when the at least one function initiated by the actuation element is intended to be modified. Steps d) to f) constitute the actual charging process of the electric vehicle and may thus be repeated in every charging process. Depending on the function of the actuation element, step e) may take place at any desired time, preferably after step c).

In an embodiment, the actuation element may be assigned according to step b) by way of the charger, and more preferably by the charging control device and/or by a mobile terminal, as described above.

In further embodiments, the assignment according to step b) may furthermore comprise the operator selecting the at least one desired function from a plurality of eligible functions on a user interface, processing the selection by a processing unit associated with the charger, assigning the at least one selected function to the actuation element, and storing this assignment. The at least one function may also be assigned to the actuation element by the processing unit.

### BRIEF DESCRIPTION OF THE DRAWING

FIG. 1 is a schematic illustration of a preferred embodiment of a charging system according to the invention.

### DETAILED DESCRIPTION OF SPECIFIC EMBODIMENTS

A charger 2 according to the invention for charging a battery 5 of an electric vehicle 4 comprises a charging control device 6 for controlling charging parameters, a grid-side connector 8 for connecting charger 2 to a power grid (indicated by a power outlet 10), and a charging plug 12 according to the invention for connecting charger 2 to a charging port 14 of electric vehicle 4.

In the illustrated embodiment, charger 2 is configured as a mobile charger in which grid-side connector 8 is connected to charging control device 6 by way of a first charging cable 16, and charging plug 12 is connected to charging control device 6 by way of a second charging cable 18.

Charging plug 12 preferably comprises a housing 20 made of plastic and, at its vehicle-side end, a consumer-side connector 22 for connecting charging plug 12 to a charging port 14 of electric vehicle 4. Consumer-side connector 22 is preferably configured with IEC Type 2 coupling.

Charging plug 12 additionally comprises an actuation element 24 for initiating at least one function that is associated with the charging process of electric vehicle 4. Actuation element 24 is arranged on housing 20 of charging plug 12 such that it is able to be actuated easily when charging plug 12 is plugged into charging port 14 of electric vehicle 4.

Charging plug 12 comprises a plurality of electrical lines 26 for connecting consumer-side connector 22 of electric vehicle 4 to charging control device 6. At least one line of the plurality of electrical lines 26 may serve as a signal line 28 for the communicative connection between consumer-side connector 22, electric vehicle 4, and charging control device 6.

A further signal line 30 is provided for communicatively connecting actuation element 24 to charging control device 6, and optionally to electric vehicle 4. This further signal line 30 is also preferably one of the plurality of electrical signal lines 26. Signal lines 28 and 30 may also be configured as a single signal line. The plurality of electrical lines 26 is preferably accommodated in second charging cable 18, which electrically insulates the plurality of electrical lines 26 from one another by way of plastic sheaths.

In order to regulate and/or monitor a charging process, charging control device 6 comprises a control unit 32 that receives signals from electric vehicle 4, from consumer-side connector 22 and from grid-side connector 8 and processes these signals and, for example, may set a charging current accordingly.

Control unit 32 includes a programmable processing unit 34 by which actuation element 24 is programmed by the operator, assigning to actuation element 24 at least one function to be initiated by actuation of element 24 from a plural set of selectable candidate functions. In other words, the function of actuation element 24 is easily programmable by the operator.

Processing unit 34 is configured to process actuation signals that have been received from actuation element 24, and following this processing, to initiate the at least one function that is assigned to actuation element 24. To this end, processing unit 34 is preferably communicatively connected to charging plug 12, electric vehicle 4, control unit 32, and/or the grid-side connector 8. Processing unit 34 transmits signals for initiating the at least one selectable function to the component in question via these communicative connections.

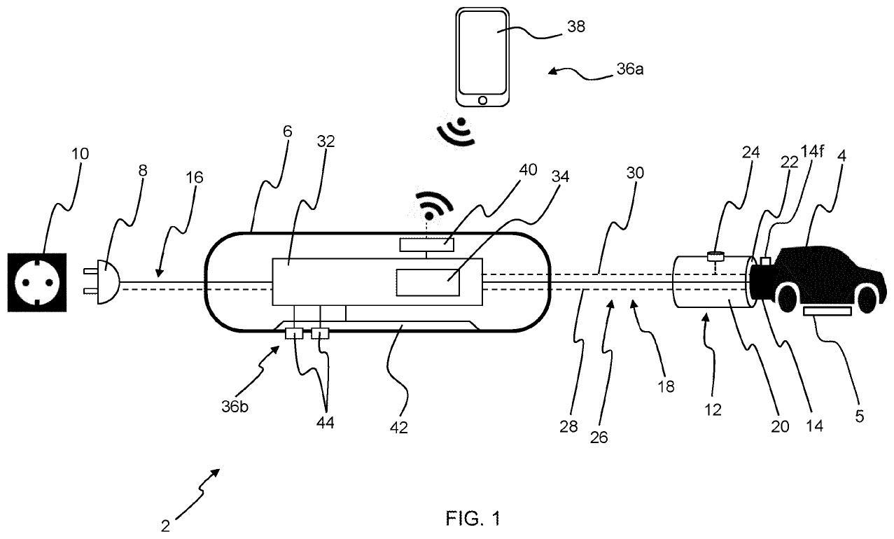

In order for the operator to program or allocate the at least one function to actuation element 24, a user interface may be provided, and FIG. 1 depicts two exemplary configurations in the form of a first user interface 36a and a second user interface 36b. First user interface 36a comprises a mobile terminal 38 such as a smartphone or tablet. An app for controlling charging control device 6 may be provided on mobile terminal 38, and such app may be used to make assignment (program) of the at least one function of actuation element 24. By way of example, the operator may select at least one function from a plurality of functions in the app and confirm the assignment of this function to actuation element 24. Mobile terminal 38 transmits such selection by the operator to charging control device 6, in particular to the processing unit 34, which performs and implements the corresponding assignment of the at least one function to actuation element 24.

Charging control device 6 may comprise a communication interface 40, preferably a wireless communication interface 40, for communicating with mobile terminal 38 or other network-compatible devices, for example via a home network. Charging control device 6 is preferably also able to communicate with a database, a cloud, or a server via communication interface 40. Communication interface 40 is additionally communicatively connected to control unit 32 and processing unit 34 of charging control device 6 in order to control charging control device 6.

Second user interface 36b comprises a display 42 and at least one operating element, here two operating elements 44, which are included on charging control device 6 and are communicatively connected to control unit 32 and processing unit 34. In this case, the operator may make and confirm the selection of the at least one function on charging control device 6 using operating elements 44. Actuation element 24 is then accordingly assigned the at least one function, again via the processing unit 34.

The set of selectable candidate functions may include one or more of the following functions:

opening a charging flap 14f of electric vehicle 4 in order to expose charging port 14,
closing charging flap 14f after the charging process has ended,
activating charging readiness of electric vehicle 4 in order to enable the charging process,
activating the charging process,
interrupting or deactivating the charging process,
continuing the charging process,
setting a charging power or a charging current before or during the charging process,
controlling charging control device 6 or the settings of charging control device 6,
controlling or setting a superordinate charging management system,
outputting light signals, audio signals, light information, or audio information on charging plug 12, on charger 2, or on mobile terminal 38,
functions regarding the environment of electric vehicle 4 to be charged, particularly at a parking space, and
identifying and/or authorizing an operator.
   Charging of electric vehicle 4 may be carried with the inventive method described below. The method includes the following steps:
providing charger 2 for charging electric vehicle 4;
the operator assigning the at least one function to actuation element 24;
connecting grid-side connector 8 of charger 2 to a power grid;
connecting consumer-side connector 22 of charging plug 12 to electric vehicle 4;
actuating actuation element 24 to initiate the at least one function when required; and
charging electric vehicle 4 using charger 2.

In this inventive method, charger 2 includes (i) charging control device 6 for regulating parameters for charging battery 5, (ii) grid-side connector for connecting the charger to a power grid, wherein the grid-side connector 8 is connected to charging control device 6, and (iii) charging plug 12 for connecting charger 2 to electric vehicle 4, wherein charging plug 12 is connected to charging control device 6. Further, charging plug 12 includes (i) consumer-side connector 22 for connecting charging plug 12 to charging port 14 of electric vehicle 4, and (ii) actuation element 24 for an operator or user of electric vehicle 4 to initiate at least one function that is associated with the charging process. Actuation element 24 is configured to be assigned the at least one function by the operator, the at least one function being selectable by the operator from a plurality of eligible functions. Actuation element 24 is thereby able to be assigned a desired function before charger 2 is used to charge electric vehicle 4, in order to simplify subsequent charging processes.

While the principles of this invention have been described in connection with specific embodiments, it should be understood clearly that these descriptions are made only by way of example and are not intended to limit the scope of the invention.

1-15. (canceled)

16. A charging plug for charging a battery of an electric vehicle wherein the charging plug comprises:
a consumer-side connector for connecting the charging plug to a charging port of the electric vehicle;
an actuation element for an operator or user of the electric vehicle to initiate at least one function that is associated with a charging process, wherein the actuation element is configured to be assigned the at least one function by the operator, which function is selectable by the operator from a plurality of eligible functions.

17. The charging plug of claim 16 wherein the charging plug comprises a plurality of electrical lines for connecting the consumer-side connector to a charging control device.

18. The charging plug of claim 16 further including a signal line for communicatively connecting the actuation element to a charging control device.

19. The charging plug of claim 16 wherein the plurality of eligible functions comprises one or more of the following functions:
a) opening a charging flap of the electric vehicle in order to expose the charging port,
b) closing the charging flap after the charging process has ended,
c) activating charging readiness of the electric vehicle in order to enable the charging process,
d) activating the charging process,
e) interrupting or deactivating the charging process,
f) continuing the charging process,
g) setting a charging power or a charging current before or during the charging process,
h) controlling the charging control device or settings thereof,
i) controlling or setting a superordinate charging management system,
j) outputting light signals or audio signals or light information or audio information on the charging plug, on a charger, or on a mobile terminal,
k) a function regarding the environment of the electric vehicle, and
i) identifying and/or authorizing an operator.

20. The charging plug of claim 16 wherein the actuation element is able to be assigned the at least one function by the operator using a user interface.

21. The charging plug of claim 16 wherein the actuation element is configured as a button, a switch, or a sensor.

22. The charging plug of claim 16 wherein the consumer-side connector is configured as an IEC Type 2, an IEC Type 1 or a CCS connector.

23. The charging plug of claim 16 wherein the actuation element is configured to permit assignment of at least two functions of the plurality of functions, wherein the at least two functions are initiated by different types of actuation of the actuation element.

24. The charging plug of claim 23 wherein the different types of actuation comprise different actuation durations, numbers of actuations, actuation frequencies, or a combination thereof.

25. A charger for charging a battery of an electric vehicle, the charger comprising:
a charging control device for regulating parameters for the charging of the battery;
a grid-side connector for connecting the charger to a power grid, wherein the grid-side connector is connected to the charging control device; and
a charging plug for connecting the charger to the electric vehicle, wherein the charging plug is connected to the charging control device and includes:
a consumer-side connector for connecting the charging plug to a charging port of the electric vehicle; and
an actuation element for an operator or user of the electric vehicle to initiate at least one function that is associated with the charging process, the actuation element being configured to be assigned the at least one function by the operator, the at least one function being selectable by the operator from a plurality of eligible functions.

26. The charger of claim 25 further including a user interface for the operator to assign the at least one function to the actuation element.

27. The charger of claim 25 wherein the charging control device has a wireless communication interface.

28. The charger of claim 25 wherein the charging control device has a wired communication interface.

29. A method for charging the battery of an electric vehicle, the method comprising the steps of:
providing a charger for charging the battery, the charger including:
a charging control device for regulating charging parameters;
a grid-side connector for connecting the charger to a power grid, wherein the grid-side connector is connected to the charging control device; and
a charging plug for connecting the charger to the electric vehicle, wherein the charging plug is connected to the charging control device and includes:
a consumer-side connector for connecting the charging plug to a charging port of the electric vehicle; and
an actuation element for an operator or user of the electric vehicle to initiate at least one function that is associated with the charging process, the actuation element being configured to be assigned the at least one function by the operator, the at least one function being selectable by the operator from a plurality of eligible functions;
the operator assigning the at least one function to the actuation element;
connecting the grid-side connector of the charger to a power grid;
connecting the consumer-side connector of the charging plug to the electric vehicle;
actuating the actuation element in order to initiate the at least one function when required; and
charging the electric vehicle using the charger.

30. The method of claim 29 wherein the actuation element is assigned by the charging control device.

31. The method of claim 29 wherein the actuation element is assigned by a mobile terminal.

32. The method of claim 29 wherein assignment step comprises:
selecting the at least one function on a user interface;
processing the at least one function by a processing unit associated with the charger; and
assigning the at least one selected function to the actuation element and storing this assignment.
